(19) United States
(12) Patent Application Publication
(10) Pub. No.: US 2009/0145039 A1
(43) Pub. Date: Jun. 11, 2009

(54) ANTI-DERAILING CLIP FOR TRACK MOUNTED DOORS

(75) Inventor: Matthew J. Shehoski, Gilbertsville, PA (US)

Correspondence Address: SUTHERLAND ASBILL & BRENNAN LLP, 999 PEACHTREE STREET, N.E., ATLANTA, GA, 30309, US

(73) Assignee: MAAX BATH INC., Lachine (CA)

(21) Appl. No.: 12/269,420

(22) Filed: Nov. 12, 2008

Related U.S. Application Data
(60) Provisional application No. 60/987,944, filed on Nov. 14, 2007.

(51) Int. Cl. E05D 15/06; A44B 21/00; A47B 96/06

(52) U.S. Cl. 49/409; 24/519; 248/205.1

(57) ABSTRACT

A sliding door mounting assembly for slidably mounting a door panel to an overhead track. The sliding door mounting assembly includes a hanging bracket member and an anti-derailing pin. The hanging bracket member is securable to the door panel, slidably engageable with the track, and has a channel extending therethrough. The anti-derailing pin has an outer surface with at least one tooth protruding outwardly therefrom, is insertable in the channel and is configurable in an anti-derailing position where at least one of the teeth is engaged with the hanging bracket member and a leading end of the anti-derailing pin abuts the track, preventing the hanging bracket member having the door panel secured thereto from derailing from the track.

### CROSS-REFERENCE TO RELATED APPLICATIONS

This application claims priority of U.S. provisional patent application No. 60/987,944 filed on Nov. 14, 2007 by Applicant.

### BACKGROUND OF THE INVENTION

1. Field of the Invention

The invention relates to sliding doors and, more particularly, to an anti-derailing device for doors suspended from and slidable along an overhead track.

2. Description of the Prior Art

Bathing enclosures often have an opening that is closed with a pair of sliding doors which are mounted in a “header” proximate to the top of the enclosure. Doors typically slide in separate, parallel tracks within the header and are able to slide past each other. A pair of rollers is mounted to each door that rides in a groove in an overhead track. They enable the door to glide in a horizontal direction along the header.

For relatively easily mounting and dismounting the doors to and from the header, a relatively large gap is provided between the roller and the upper wall of the header. Absent other structures, the rollers may be inadvertently derailed due to this gap. For example, if the door is shut with too much force it may rebound upward instead of just straight back along the track.

To substantially avoid the derailment problem, threaded fasteners are installed and abut a section of the header, such as the upper wall or the rail structure. However, upon the back and forth movement of the door, the fasteners unscrewed and, thereby, recreating the gap between the roller and the abutting wall of the header. A screwdriver is required to rotate them until they abut the abutting wall of the header.

### BRIEF SUMMARY OF THE INVENTION

It is therefore an aim of the present invention to address at least one of the above mentioned issues.

According to a general aspect, there is provided a sliding door mounting assembly for slidably mounting a door panel to an overhead track. The sliding door mounting assembly includes a hanging bracket member and an anti-derailing pin. The hanging bracket member is securable to the door panel, slidably engageable with the track, and has a channel extending therethrough. The anti-derailing pin has an outer surface with at least one tooth protruding outwardly therefrom, is insertable in the channel and is configurable in an anti-derailing position where at least one of the teeth is engaged with the hanging bracket member and a leading end of the anti-derailing pin abuts the track, preventing the hanging bracket member having the door panel secured thereto from derailing from the track.

According to another general aspect, there is provided a sliding door system comprising a track; a door panel slidably mounted to the track; a clip member mounted to the door panel and having a channel extending therethrough and an anti-derailing pin having an outer surface with at least one tooth protruding outwardly therefrom, being insertable in the channel, and being configurable in a locked position wherein a tip of the anti-derailing pin abuts the track and at least one of the at least one tooth is engaged with the clip member preventing displacement of the anti-derailing pin along the channel and derailing of the door panel from the track.

According to a further general aspect, there is provided an anti-derailing clip for a sliding door panel assembly engageable with a track, the anti-derailing clip comprising: a clip member mounted to the sliding door panel assembly and having a channel extending therethrough; and a pin having an outer surface with at least one tooth protruding outwardly therefrom and the pin being insertable in the channel with at least one of the at least one tooth engageable in a locked configuration with the clip member to prevent displacement of the pin in the channel, the pin abutting the track in the locked configuration and preventing disengagement of the sliding door panel assembly from the track.

### BRIEF DESCRIPTION OF THE DRAWINGS

FIG. 1 is a side elevation view of a door system mounted to a tiled shower;

FIG. 2 is a perspective view of a sliding door mounting assembly mounted to an overhead track in accordance with an embodiment, wherein the overhead track and a door panel are partly sectioned;

FIG. 3 is a cross-sectional view of the sliding door mounting assembly shown in FIG. 2;

FIG. 4 is a perspective view of the sliding door mounting assembly shown in FIG. 2, dismounted from the overhead track;

FIG. 5 is a perspective view, exploded, of the sliding door mounting assembly shown in FIG. 2;

FIG. 6 is a perspective view of an anti-derailing clip of the sliding door mounting assembly shown in FIG. 2;

FIG. 7 includes FIGS. 7a, 7b, and 7c and is a cross-sectional view of the anti-derailing clip shown in FIG. 6 in a disengaged configuration, an unlocked position, and a locked position of a pin respectively; and

FIG. 8 is a schematic side elevation view, sectioned, of a user applying pressure on a head of the pin to configure the anti-derailing clip shown in FIG. 6 in the locked configuration.

It will be noted that throughout the appended drawings, like features are identified by like reference numerals.

### DETAILED DESCRIPTION

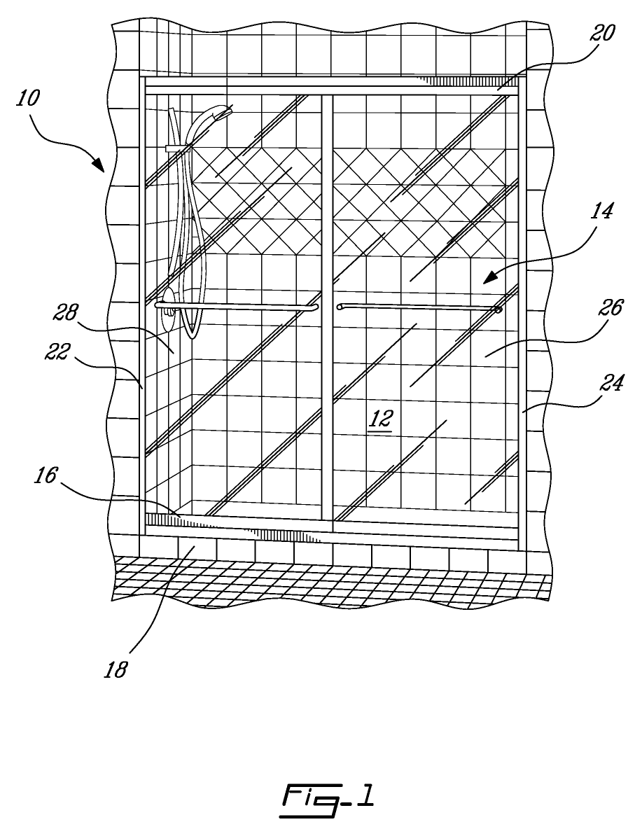

Referring to FIG. 1, there is shown a tiled shower 10 located in a recess formed by walls 12.

The shower recess is closed by a door system 14 which includes a lower track 16 mounted on a front rim 18 and an overhead track 20 which extends directly over and parallel to the lower track 16. Two wall jambs 22, 24, spaced-apart from one another, extend vertically along the side walls between the tracks 16, 20. The opening of the shower enclosure is defined by the tracks 16, 20 and the wall jambs 22, 24.

Two doors 26, 28, which can be glass-panel doors, are suspended from the overhead track 20 in the enclosure opening and extend downwardly into the lower track 16. In the embodiment shown, the doors 26, 28 can slide in either direction past one another along the two tracks 16, 20 to create a passageway adjacent either side walls through which a bather enters and exits the shower 10. However, in an alternative embodiment (not shown), the doors can be slidable in only one direction.

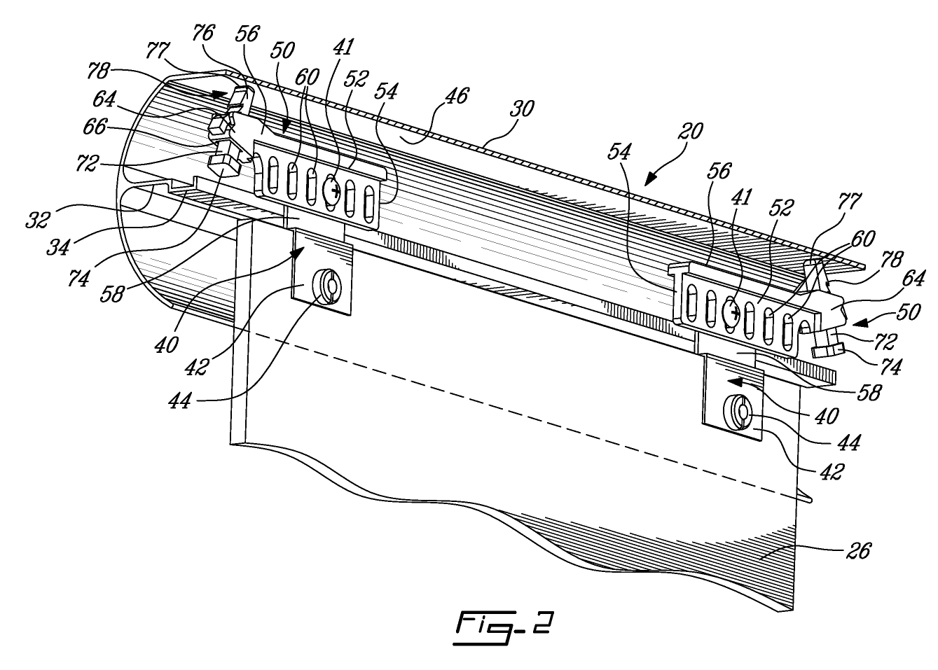

Referring now to FIGS. 2 and 3, there is shown that the overhead track 20 is formed by an elongated channel/header member 30 with an inverted U-shaped cross section and having two longitudinal rail support 32a, 32b extending within the opening of the header 30. Each support 32a, 32b has a longitudinal rail 34a, 34b defined therein, both rails 34a, 34b extend parallel to one another.

Each sliding door mounting assembly includes a roller 36, which rides in a respective rail 34. More particularly, the rollers 36a for the door 26 ride within rail 34a, while the door rollers 36b for the door 28 ride within rail 34b. The rollers 36a, 36b are mounted on a respective axle 38 attached to a roller fastener 41, such as a screw, at it will be described in more details below. The rollers 36a, 36b are mounted to a outer side 39 of a respective door mounting bracket 40.

The door mounting brackets 40a, 40b define an inverted U-shape channel 42a, 42b in their lower section, the openings of which receive the top of a respective one of the door panels 26, 28. The door panels 26, 28 are secured with door panel fasteners 44 to the mounting brackets 40a, 40b. In this arrangement, the doors 26, 28 hang plumb substantially directly below their respective rollers 36a, 36b.

From FIG. 3, it is understood that in that embodiment, two roller and bracket assemblies (or sliding door mounting assemblies) are spaced apart along the top edge of each door panel 26, 28, adjacent each opposite lateral end of the doors 26, 28. In an alternative embodiment, it should be appreciated that any numbers of such assemblies can be mounted to each door 26, 28. The roller and bracket assemblies are also spaced apart from the upper wall 46 of the header member 30.

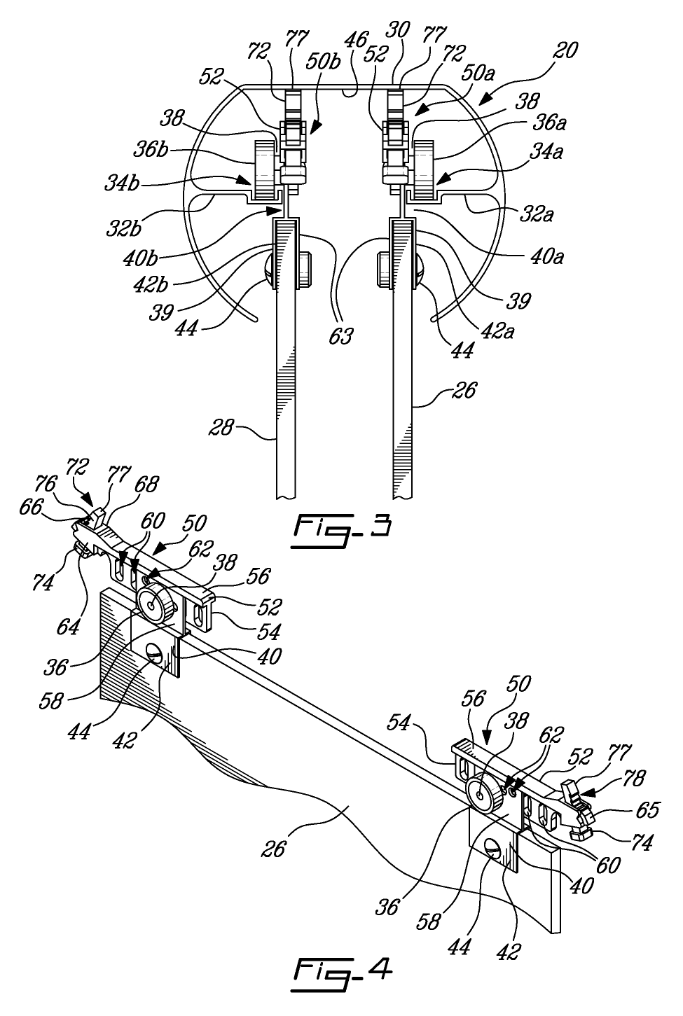

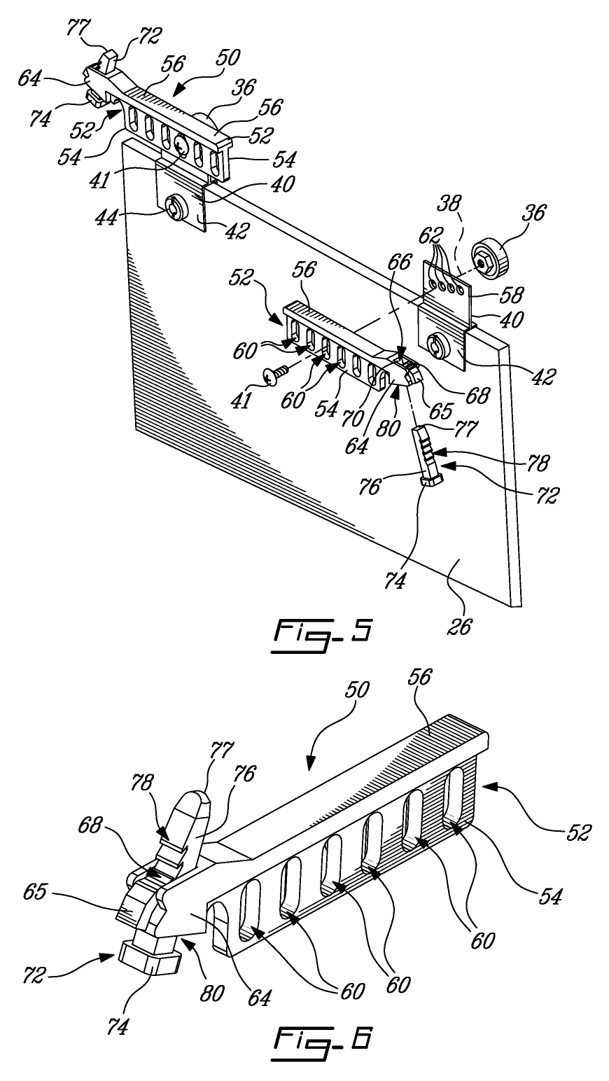

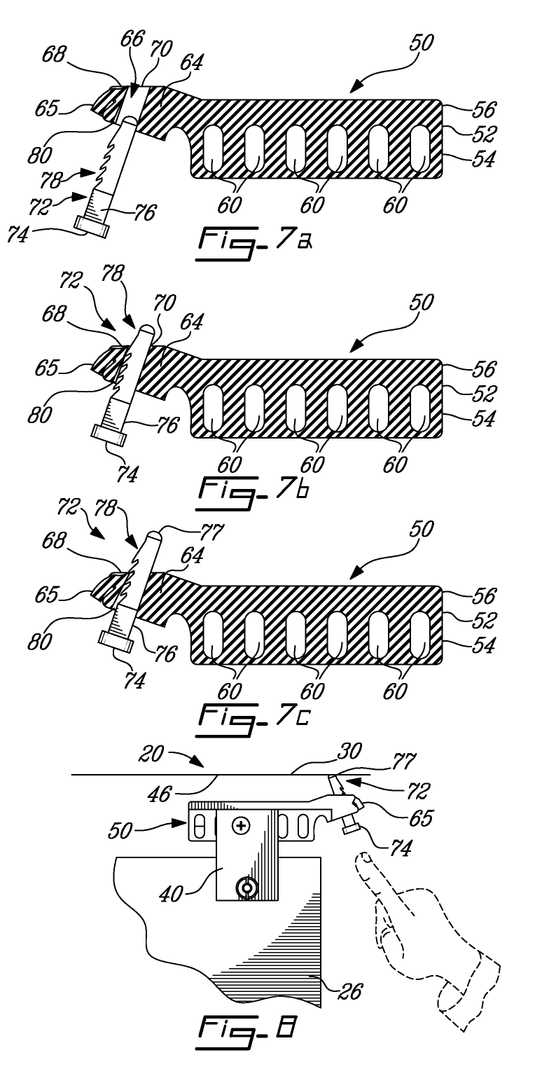

Now referring simultaneously to FIGS. 2, 4 and 5, there is shown that anti-derailer clips 50a, 50b, or anti-jump clips, are mounted to the upper section 58 of the door mounting brackets 40a, 40b. Each anti-derailer clip 50a, 50b includes a mounting plate 52 with a lower section 54 and an upper section 56. The lower section 54 of the mounting plate 52 is secured to the upper section 58 of a respective one of the door mounting brackets 40a, 40b. Both the lower section 54 of the anti-derailer clip 50 and the upper section 58 of the door mounting bracket 40 include a plurality of holes 60, 62. The roller fastener 41 extends continuously in one of the anti-derailer clip hole 60 and one of the door mounting bracket hole 62. Therefore, the roller fastener 41 connects together the anti-derailer clip 50, the door mounting bracket 40, and the roller 36 and acts as an axle for the roller 36. The position of the door panel 26, 28 and the anti-derailer clip 50 relatively to one another can be adjusted by inserting the roller fastener 41 in different holes 60, 62.

The anti-derailer clip 50 is mounted on an inner side 63 of the mounting brackets 40a, 40b while the door rollers 36a, 36b are mounted on the outer side 39 of the mounting brackets 40a, 40b, as mentioned above.

The anti-derailer clip 50 also includes a pin mounting section 64, continuous to the upper section 56. The anti-derailer clip 50 includes a ratchet member 65, or pawl, is pivotally mounted to the pin mounting section 64, the purpose of which will be described in more details below. The pin mounting section 64 has a channel 66 extending therethrough. A ratchet edge 68, i.e. the tip of the pawl 65, extends at the periphery of an upper port 70 of the channel 66.

A pin 72 having a head 74, a shank 76, and a tip 77, opposite from the head 74, is slidably insertable in the channel 66. The pin 72 has a plurality of engaging teeth 78 on at least one outer wall of the shank 76. The teeth 78 are designed to be engaged by the ratchet edge 68 of the pawl 65 when the pin 72 is inserted in the channel 66. Moreover, the pawl 65 can be pivoted, about its pivot axis, to move upwardly the pin 72 within the channel 66, as it will be described in more details below. In the embodiment shown, the diameter of the head 74 is larger than the diameter of the lower port 80 of the channel 66, preventing thereby the head 74 to be inserted in the channel 66.

The tip 77 is designed to abut the upper wall 46 of the header member 30, as shown in FIG. 2.

Referring now to FIG. 5, it will be seen that when the door 26, for example, is being assembled onto the overhead track 20, the anti-derailer clip 50 is simultaneously mounted to the mounting bracket 40. However, the pin 72 is not inserted (FIG. 7a), i.e. in a disengaged configuration, or not completely inserted in the channel 66 (FIG. 7b), i.e. in an unlocked position, thereby leaving a sufficiently large gap between the bottom of the rail 34 and the upper wall 46 of the header member 30 to fit the roller 36 in the rail 34.

Once the roller 36 is engaged with the rail 34, the gap is no longer helpful and, in fact, allows the door 26 to too easily derail. Thus, the pin 72 is inserted in the channel 66 or pushed further in the channel 66 until the tip 77 abuts the upper wall 46 of the header 30. The pin 72 is thus configured in a locked position as shown in FIG. 7c.

For displacing the pin 72 in the channel 66, either pressure can be applied to the head 74 or the pawl 65 can be pivoted, about its pivot axis, to move upwardly the pin 72 within the channel 66 by simultaneously engaging consecutive teeth 78.

In the locked configuration, one of the teeth 78 of pin 72 engages the ratchet edge 68 preventing the pin 72 from sliding out of the channel 66 when pressure is applied on its tip 77.

Therefore, the anti-derailer clip 50 reduces the gap between the roller 36 and the upper wall 46 of the header 30 such that the door 26 cannot be removed from the track 20 without sliding out or removing the pin 72 from the channel 66. If door 26 is lifted or tilted, the tip 77 of the anti-derailer clip 50 remains in contact with the upper wall 46 of the header 30 before the rollers 36 cannot to leave the rail groove 34. Thus the pin 72 acts as a stopper preventing the door from derailing from the track 20.

As mentioned above, the door can be removed from the track 20 by disengaging the teeth 78 from the pawl 65, lowering the pin 72 in a respective channel 66 of the anti-derailer clip 50 and reversing the steps of the assembly process.

The engagement of the teeth 78 protruding from the shank 76 of the pin 72 with the ratchet edge 68 prevents the pin 72 from sliding out of the channel 66 when pressure, below a relatively high threshold, is applied to the tip 77. If the pressure applied to the tip 77 is above the threshold, the pin 72 lowers or slides out from the channel 66. However, the pin 72 can be relatively easily replaced in its original position, without requiring any extra tools, by simply applying a relatively low pressure on the head 74 until the tip 77 abuts the upper wall 46 of the header member 30, as shown in FIG. 8, or pivoting the pawl 65 about its pivot axis. The head 74 is relatively accessible when the door panel assembly is mounted to the overhead track 20.

The teeth 78 are configured to permit a relatively easy displacement of the pin 72 in the channel 66 along one direction and restraint the displacement in the opposite direction. In the embodiment shown, the displacement of the pin 72 in the channel 66 is relatively easy when applying pressure to the head 74 or pivoting the pawl about its pivot axis. The teeth 78 provides a ratchet action to maintain the pin 72 in the locked position when pressure is applied to the tip 77.

The present invention provides sliding door structures for use in closing off bathing enclosures or the like. These structures are resistant to derailing, with the anti-derailing feature being connected and unconnected without extra tools

The anti-derailer clip 20 can be made from a substantially rigid plastic, such as a semi-rigid resin, for instance. Other materials may be suitable as well, depending on the environment in which the system is used.

In bypass door type systems (such as would be used desirable to control access to a shower enclosure), there can be two doors, each hanging from a separate rail by at least two rollers attached to at least two hanging brackets secured by two anti-derailing clips. The anti-jump clip provides a door assembly which is substantially resistant to derailing and relatively easy to readjust. Moreover, the anti-derailing feature can be activated and deactivated relatively quickly, without special tools.

Although the door system is being described in the context of shower stalls, it also can be applied to tubshowers, i.e. a bathtub with shower region above the tub basin, shower stalls, and other bathing device and building enclosures.

The embodiments of the invention described above are intended to be exemplary only.

For example, the door system 14 can include one or more door panels 26, 28 and their configuration can differ from the embodiment described above. The rail 34 can be replaced by any appropriate groove or system allowing a sliding displacement of the door panels 26, 28. Moreover, the rollers 36 can be replaced by any other component allowing a sliding displacement of the door panels 26, 28. The design of the header 30 can differ from the one of FIGS. 2 and 3.

In an alternative embodiment, the door mounting bracket 40 and the anti-derailing clip 50 can be single piece.

In an alternative embodiment, the roller 36 can be mounted to the inner side of the door mounting bracket 40 and the anti-derailing clip 50 can be mounted to the outer side of the door mounting bracket 40, for instance. Moreover, in another alternative embodiment, they can be mounted to the same side of the door mounting bracket 40, either the inner side or the outer side.

The design of the anti-derailing clip 50, including the pin 72 and the channel 66, can differ from the one of the above-described embodiment.

The pin 72 can include a single engaging tooth 78 or any number of engaging teeth 78. Moreover, they can be provided on a plurality of outer walls of the shank 76.

In an alternative embodiment, the tip 77 of the pin 72 can abut any other section or wall of the header member 30. For instance, it can abut the rail support 32. Therefore, the anti-derailing clip 50 can be mounted below the rail 34.

The anti-derailing clip 50 can be mounted to the mounting bracket 40 before or after mounting the door panel 26, 28 to the overhead track 20.

In an alternative embodiment, the mounting plate 52 and the pawl 65 can be single-piece. Moreover, the pawl 65 can be a fixed component. In another alternative embodiment, the pawl can be removed and the teeth can abut an edge or a protuberance of the anti-derailing clip.

The header can include any number of rail. The anti-derailing clip can be mounted to the lower track. Only one roller assembly can include the anti-derailing clip and the anti-derailing clip can be mounted differently from the above-described structure. For instance and without being limitative, it can be mounted as a separate component from the hanging bracket.

The scope of the invention is therefore intended to be limited solely by the scope of the appended claims.

1. A sliding door system comprising:
a track;
a door panel slidably mounted to the track;
a clip member mounted to the door panel and having a channel extending therethrough; and
an anti-derailing pin having an outer surface with at least one tooth protruding outwardly therefrom, being insertable in the channel, and being configurable in a locked position wherein a tip of the anti-derailing pin abuts the track and at least one of the at least one tooth is engaged with the clip member preventing displacement of the anti-derailing pin along the channel and derailing of the door panel from the track.

2. A sliding door system as claimed in claim 1, wherein the clip member comprises a pivotable pawl having an edge engageable with the at least one tooth of the anti-derailing pin and preventing displacement of the anti-derailing pin in the channel, the at least one protuberance abutting the pivotable pawl in the locked position.

3. A sliding door system as claimed in claim 2, wherein the pivotable pawl is mounted outwardly of the clip member.

4. A sliding door system as claimed in claim 1, wherein the at least one tooth abuts a section of the clip member in the locked position.

5. A sliding door system as claimed in claim 1, wherein the anti-derailing pin comprises a series of linearly extending teeth protruding outwardly from the outer surface.

6. A sliding door system as claimed in claim 1, wherein the track comprises a longitudinal rail and a track upper wall spaced apart and extending above the longitudinal rail, the door panel being slidingly mounted to the longitudinal rail for sliding displacement therealong and the tip of the anti-derailing pin abutting the track upper wall in the locked position.

7. A sliding door system as claimed in claim 1, wherein the door panel is slidingly mounted to the track through a hanging bracket having a roller engaged in a longitudinal rail of the track for sliding displacement of the door panel therein, the clip member being mounted to the hanging bracket with the pin abutting an upper wall of the track in the locked position.

8. A sliding door system as claimed in claim 1, wherein the channel defines an angle ranging between 10° and 85° with the track.

9. An anti-derailing clip for a sliding door panel assembly engageable with a track, the anti-derailing clip comprising:
a clip member mounted to the sliding door panel assembly and having a channel extending therethrough; and
a pin having an outer surface with at least one tooth protruding outwardly therefrom and the pin being insertable in the channel with at least one of the at least one tooth engageable in a locked configuration with the clip member to prevent displacement of the pin in the channel, the pin abutting the track in the locked configuration and preventing disengagement of the sliding door panel assembly from the track.

10. An anti-derailing clip as claimed in claim 9, wherein the sliding door panel assembly is engaged with the track through a hanging bracket and roller assembly and the clip member is securable to the hanging bracket and roller assembly.

11. An anti-derailing clip as claimed in claim 9, wherein the clip member comprises a pivotable pawl having an edge engageable with the at least one tooth of the pin and preventing displacement of the pin in the channel, the at least one tooth abutting the pivotable pawl in the locked configuration.

12. An anti-derailing clip as claimed in claim 11, wherein the pivotable pawl is mounted outwardly of the clip member.

13. An anti-derailing clip as claimed in claim 9, wherein the at least one tooth abuts a section of the clip member in the locked configuration.

14. An anti-derailing clip as claimed in claim 9, wherein the pin comprises a series of teeth extending longitudinally and parallel to one another on an outer wall of the pin.

15. An anti-derailing clip as claimed in claim 9, wherein the pin comprises a head accessible when the pin is inserted in the channel.

16. An anti-derailing clip as claimed in claim 9, wherein the channel defines an angle ranging between 10° and 85° with the track.

17. A sliding door mounting assembly for slidably mounting a door panel to an overhead track; the sliding door mounting assembly comprising:
a hanging bracket member securable to the door panel, slidably engageable with the overhead track, and having a channel extending therethrough; and
an anti-derailing pin having an outer surface with at least one tooth protruding outwardly therefrom and the anti-derailing pin being insertable in the channel and configurable in an anti-derailing position where at least one of the at least one tooth is engaged with the hanging bracket member and a leading end of the anti-derailing pin abuts the track preventing displacement of the anti-derailing pin in the channel and preventing the hanging bracket member having the door panel secured thereto from derailing from the track.

18. A sliding door mounting assembly as claimed in claim 17, wherein the hanging bracket member comprises a pivotable pawl having an edge engageable with the at least one tooth of the anti-derailing pin and preventing displacement of the anti-derailing pin in the channel, when engaged with the at least one tooth.

19. A sliding door mounting assembly as claimed in claim 17, wherein the anti-derailing pin comprises a series of linearly extending teeth protruding outwardly from the outer surface.

20. A sliding door mounting assembly as claimed in claim 17, wherein the overhead track comprises a longitudinal rail and a track upper wall spaced apart and extending above the longitudinal rail, the door panel being slidingly mounted to the longitudinal rail for sliding displacement therein and the tip of the anti-derailing pin abutting the upper wall in the anti-derailing position.

21. A sliding door mounting assembly as claimed in claim 17, wherein the hanging bracket member has a roller engaged in a longitudinal rail of the overhead track for sliding displacement of the door panel therein with the anti-derailing pin abutting an upper wall of the track in the anti-derailing position.

22. A sliding door mounting assembly as claimed in claim 17, wherein the channel defines an angle ranging between 10° and 85° with the overhead track.
